(19) United States
(12) Patent Application Publication
(10) Pub. No.: US 2017/0159866 A1
(43) Pub. Date: Jun. 8, 2017

(54) AN OFFSHORE PIPE SYSTEM AND A METHOD OF HEATING UNBONDED FLEXIBLE PIPES IN AN OFFSHORE PIPE SYSTEM

(71) Applicant: NATIONAL OILWELL VARCO DENMARK I/S, Brøndby (DK)

(72) Inventor: Kristian Glejbøl, Glostrup (DK)

(21) Appl. No.: 15/316,545

(22) PCT Filed: Jun. 22, 2015
(86) PCT No.: PCT/DK2015/050175

§ 371 Date: Dec. 6, 2016

(30) Foreign Application Priority Data
Jun. 30, 2014 (DK) PA 2014 70404

(51) Int. Cl. F16L 53/00

(52) U.S. Cl. CPC F16L 53/007

(57) ABSTRACT

The present invention relates to an offshore pipe system comprising a first unbonded flexible pipe and a second unbonded flexible pipe for transportation of fluids such as oil or gas. Each of the unbonded flexible pipes comprises a sealing sheath and an electrically conductive armor layer, and, moreover, the system comprises a first end fitting connected to the first end of the first unbonded flexible pipe and a second end fitting connected to the first end of the second unbonded flexible pipe. In the offshore pipe system the electrically conductive armor layer of the first unbonded flexible pipe is electrically connected with the electrically conductive armor layer of the second unbonded flexible pipe via a first electrical connection and a second electrical connection. To obtain an electrical circuit the first and second electrical connections are applied with a distance along the length of the first unbonded flexible pipe and the second unbonded flexible pipe, respectively. The invention also relates to a method for heating pipes by forming an electrical circuit between the pipes.

### TECHNICAL FIELD

The invention relates to an offshore pipe system comprising unbonded flexible pipes for offshore and subsea transportation of fluids, in particular fluids which solidify if subjected to a temperature drop, such as hydrocarbons, water and mixtures hereof. The invention also relates to a method for heating unbounded flexible pipes in an offshore pipe system.

### BACKGROUND ART

Flexible unbonded pipes of the present type are for example described in the standard “Recommended Practice for Flexible Pipe”, ANSI/API 17 B, fourth Edition, July 2008, and the standard “Specification for Unbonded Flexible Pipe”, ANSI/API 17J, Third edition, July 2008. Such pipes usually comprise an innermost sealing sheath—often referred to as an internal pressure sheath, which forms a barrier against the outflow of the fluid which is conveyed in the bore of the pipe, and one or usually a plurality of armoring layers. Often the pipe further comprises an outer protection layer which provides mechanical protection of the armor layers. The outer protection layer may be a sealing layer sealing against ingress of sea water. In certain unbonded flexible pipes one or more intermediate sealing layers are arranged between armor layers.

In general flexible pipes are expected to have a lifetime of 20 years in operation.

The term “unbonded” means in this text that at least two of the layers including the armoring layers and polymer layers are not bonded to each other. In practice the known pipe normally comprises at least two armoring layers located outside the inner sealing sheath and optionally an armor structure located inside the inner sealing sheath normally referred to as a carcass.

These armoring layers comprise or consist of multiple elongated armoring elements that are not bonded to each other directly or indirectly via other layers along the pipe. Thereby the pipe becomes bendable and sufficiently flexible to roll up for transportation.

Unbonded flexible pipes are often used e.g. as riser pipes in the production of oil or other subsea applications. One of the difficulties in the production of crude oil and other fluids from reserves located in deep waters is that the crude oil normally has a temperature which is relatively high compared to the temperature of the surrounding sea water and during transportation from the reservoir to a top-site production platform or when transported in a flow line, the fluid is cooled down to a lower temperature which may increase the viscosity of the fluid or even result in more or less blocking of the pipe due to the formation of hydrates and waxes or other solidified substances.

In order to avoid undesired cooling down of a fluid in an unbonded flexible pipe, it is well known to provide the unbonded flexible pipe with one or more thermal insulation layers. The thermal insulation of subsea pipelines is a practice which in certain situations does not provide a sufficient protection against formation of solidified substances in the fluid, such as in case of temporary production stop. As temporary production stops cannot be fully avoided, it is essential that the pipe system is designed to ensure that the pipe is not blocked by solidified substances during a temporary production stop. Removal of a blocking in a pipe can be very difficult and costly and in worst case it is not possible to remove the blocking and as a result the whole pipe must be replaced.

Several methods of actively heating the pipe have been described in the art. These methods can be categorized in two groups, namely a group using flowing of hot fluids in selected spaces within the pipe wall and a group using electric heating.

EP 485 220 discloses an electric heating system for subsea flexible pipelines which includes the provision of an electric unit consisting of a controlled rectifying unit, which is the source of current, an electric cable positioned in parallel with the flexible pipeline for the return of the current, and two terminal connectors which electrically insulate the double-reinforced crossed armoring, the electric current being conducted by the tensile armoring or the carcass and returning by an electric cable installed outside the flexible pipeline.

U.S. Pat. No. 7,123,826 discloses a pipe comprising a tubular member formed of a plastic material, and a plurality of electrical current conductive materials dispersed in the plastic material for increasing the electrical conductivity of the tubular layer, so that when electrical power is supplied to the conductor, the current flows through the materials to heat the pipe and the fluids.

US 2012/0217000 discloses a system for electrical heating of risers or pipes which have at least two concentric layers of metal wires adapted to be used for low-voltage direct electric heating (LV-DEH), each pair being provided to heat a specific segment of a riser or a pipe. The system can be used for both the pipeline and the riser up to a top site structure.

In principle the prior art systems provide suitable methods of heating the pipeline. However, there is still a need for system for heating two or more unbonded flexible pipes in an offshore system which provides both a good protection against blocking of the pipe in the event of a temporary production stop while simultaneously being simple and safe.

### DISCLOSURE OF INVENTION

An object of the present invention is to provide an offshore pipe system comprising unbonded flexible pipes suitable for use as risers or flowlines for transporting fluids from a subsea facility e.g. to a top site structure or along the seabed in a flowlines, where the pipes can be subjected to electric heating in a simple and cost effective way.

The present invention provides an offshore pipe system comprising unbonded flexible pipes suitable for use in transporting fluids from a subsea facility, where the pipes in case of a temporary production stop can be subjected to an electric heating while simultaneously having low risk of side effects due to the application of current.

Moreover, the present invention provides an offshore system comprising unbonded flexible pipes suitable for use as risers or as flowlines for transporting fluids from a subsea facility to a production site structure, where the pipes in case of a temporary production stop can be subjected to an electric heating in a simple and cost effective way and with low risk of undesired side effects due to application of current.

These advantages are provided by the invention as defined in the claims and described herein.

It has been found that the invention and/or embodiments thereof have a number of additional advantages which will be clear to the skilled person from the following description.

The offshore pipe system according to the invention comprises unbonded flexible pipes which in particular are in the form of two or more unbonded flexible pipes for transportation of fluids from a subsea facility to a production site structure.

As defined in the present application the unbonded flexible pipes comprise at least a first-end end-fitting and preferable a second-end end-fitting and optionally intermediate end-fittings interconnecting sections of the pipe.

In an embodiment the unbonded flexible pipes are suitable for transporting fluid between a top site structure and a subsea facility, where the top site structure is arranged at a relatively vertically higher position than the subsea facility. The top site structure can for example be a floating unit such as a floating platform or a vessel or a stationary unit. The top site structure will usually be arranged near the water line, such as within from about 25 m above the water line to about 100 m below the water line.

In an embodiment the unbonded flexible pipes are suitable for transporting fluid along the seabed in flow lines from a subsea facility to a production site structure.

The production site structure can be a top site structure as defined herein, but it can also be any other structure arranged subsea e.g. an intermediate container or another transportation pipe.

The term “water line” means the water line at still water. Unless specifically mentioned all distances and determinations in relation to the water line are made at still water at average water level.

The term “in radial direction” means a direction from the axis of the pipe and radially outwards.

The terms “inside” and “outside” a layer of the pipe are used to designate the relative distance to the axis of the pipe, such that “inside a layer” means the area encircled by the layer i.e. with a shorter axial distance than the layer and “outside a layer” means the area not encircled by the layer and not contained by the layer, i.e. with a shorter axial distance than the layer.

The term “substantially” should herein be taken to mean that ordinary product variances and tolerances are comprised.

The term “cross-wound layers” means that the layers comprise wound elongate elements that are wound in opposite direction relatively to the longitudinal axis of the pipe where the angle to the longitudinal axis can be equal or different from each other.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

The term ‘seabed’ is generally used to demote the subsea floor.

Thus, in a first aspect the present invention relates to an offshore pipe system comprising a first unbonded flexible pipe and a second unbonded flexible pipe for transportation of fluids, where each of the unbonded flexible pipes has a length along a longitudinal center axis, and a first and a second end. Moreover, each of the unbonded flexible pipes comprises a sealing sheath and an electrically conductive armor layer. The system further comprises a first end fitting connected to the first end of the first unbonded flexible pipe and a second end fitting connected to the first end of the second unbonded flexible pipe wherein the electrically conductive armor layer of the first unbonded flexible pipe is electrically connected with the electrically conductive armor layer of the second unbonded flexible pipe via a first electrical connection and a second electrical connection. The first and the second electrical connection are applied with a distance along the length of the first unbonded flexible pipe and the second unbonded flexible pipe, respectively.

According to the invention it has been realized that it is possible to electrically connect a conductive armor layer in one flexible pipe with a conductive armor layer in another flexible pipe, thereby forming an electrical circuit which may be used for heating the pipes. By connecting the armor layers in two different flexible pipes the electrical power from a power supply may be utilized more efficiently as the electrical current does not need to be returned to the power supply by an external wire, when it has passed through the armor layer in a first pipe. Consequently, the electric power may be used for heating substantially in the entire electric circuit.

The sealing sheath referred to above will in most cases be the innermost sealing sheath—also known as an internal pressure sheath. The sealing sheath is substantially liquid impermeable and electrical insulating. In some embodiments the sealing sheet may also be a thermal insulating. The unbonded flexible pipes may comprise more than one sealing sheath, e.g. an outer sealing sheath. Moreover, the unbonded flexible pipes may comprise further armor layers, e.g. of cross-wound layers of metal or fiber reinforced polymer wires, which may be electrical conductive or non-conductive.

The end fittings are well known in the art and are usually required to have a high strength. Normally such end fittings are mainly of metal. The first end fitting and the second end fitting can for example be as the end fittings known in the art with the modification with respect to electrically conductive pathways and electrical insulations described herein.

The first and the second unbonded flexible pipe also comprise a second end, which may comprise an end fitting.

In an embodiment the unbonded flexible pipes comprise from the inside and out an electrically conductive armor layer, an electrically insulating innermost sealing sheath, at least one armor layer comprising at least one helically wound wire and an outer sealing sheath which may be electrically insulating.

At least the electrically conductive armor layer is mechanically terminated in the end fitting and the pipe comprises electrical connections in the end fitting arranged to apply a voltage using a power supply over the electrically conductive layer. These electrically conductive layers are electrically interconnected between the unbonded flexible pipes preferably via the end fittings to provide an electric circuit when the power supply is applied.

Thus, the offshore pipe system also comprises a power supply which constitutes or form part of an electrical heating system.

By applying a voltage over the electrically conductive layers a current will run through the electrically conductive armor layer of the first pipe and return at least partly via the electrically conductive armor layer of the second pipe. Thereby—due to the electrical resistance of the material of the electrically conductive armor layers, heat will be generated, generally known as “Joule heating”, as the current passes through the electrically conductive armor layers and the current required to avoid solidification of substances in the bore or to remove solids may be kept relatively low and thereby any risk of undesired side effects provided by such current is even more low.

Thereby the temperature of the inner pipe may easily be maintained above the solidification temperature of the pipe even if the temperature and flow in the pipe is below the limit where solidification is expected due to heat loss. In the same way any fluids or any solidified fluids within the bore of the pipes can in a simple way be reheated to the desired temperature after a temporary production stop. No additional layers or additional conductors running externally to the pipes are required and the required amount of current can be kept low because the energy is coupled directly to the fluid. Thereby ordinary unbonded flexible pipes with metal armor layer(s) may in a simple way be modified to constitute unbonded flexible pipes in the offshore pipe system of the present invention simply by providing one or more of its end fittings with the required electrical properties as described herein.

Thus, the invention provides a very simple and cost effective way of subjecting the unbonded flexible pipes to electric heating e.g. in case of a temporary production stop, thereby preventing the pipes from being blocked due to undesired cooling. Further it has been found that the risk of side effects due to the application of current can be held relatively low e.g. as described further below.

In an embodiment of the offshore pipe system the first end of the electrically conductive layer of the first unbonded flexible pipe is impressed with an electrical potential via its first electrical connection and the electrically conductive layer of the second unbonded flexible pipe is impressed with an electrical potential in its second end via its second electrical connection such that the summarized charge flowing through the first and the second unbonded flexible pipe is substantially zero.

In this context “zero charge” should be understood as being less than 1/10 of the charge flowing through the electrical conductive layer of the first unbonded flexible pipe as it in practice will be difficult or impossible to achieve a numerical zero. In a corresponding manner “zero current” should be understood to be less than 1/10 of the current flowing through the electrical conductive layer of the first unbonded flexible pipe

When using the terms “zero net charge”, “net charge” and “zero net current” and “net current” these should be understood as the charge or current measured over a period of time e.g. a second rather than the charge or current measured at an instant moment, i.e it may be construed as the mean value over a period of time.

According to an embodiment the first end of the first unbonded flexible pipe is connected to a master potential and the potential of the second end of the second unbonded flexible pipe is actively adjusted to provide substantially zero net flow of current through the system.

In an alternative embodiment the first end of the first unbonded flexible pipe and the second end of the second unbonded flexible pipe are electrically connected to the terminals of a shared electrically floating power supply.

In the above describe situations there is no net current floating from the second ends of the connected unbonded flexible pipes and the second ends will substantially have an equilibrium potential relative to the surroundings.

The heat generated in the electrically conductive armor layers depends on the resistance R of the material constituting the electrically conductive armor layer. In this context the term “resistance R” is meant to cover the electrical resistance in a material when direct current or alternating current is applied. Normally the term “impedance” is used for describing the resistance when alternating current is applied.

The current I through the circuit comprising the power supply and the electrically conductive armor layers can be determined according to the equation:

I=V/R

Wherein V is the impressed voltage V. For constant I, the higher the resistance R is, the more heat will be generated in the material.

The electrically conductive armor layers are advantageously of metal. Preferably the material of the electrically conductive armor is a material such as steel, preferably highly alloyed steel, in particular stainless steels or nickel based alloys.

In an embodiment of the offshore pipe system according to the invention the first electrical connection between the first unbonded flexible pipe and the second unbonded flexible pipe comprises a power supply configured for applying an electric potential difference between the electrically conductive armor layers of the flexible pipes. The first electrical connection is conveniently established between the end fittings of the pipes, i.e. the first electrical connection is applied between the first and the second end fitting, which normally are connected with a production structure above the water line. In this way it is rather easy to connect the power supply with the first electrical connection. The second electrical connection is suitably applied between the second end of the first unbonded flexible pipe and the second end of the second unbonded flexible pipe. The second ends of the flexible pipes may also include end fittings which may be used for establishing the second electrical connection. The end fittings used in the present invention may correspond to the end fittings described in the international patent application PCT/DK2014/050109 which is incorporated herein by reference.

For the purpose of achieving a satisfactory heating of the electrical conductive layers the electrical potential difference should be in the range 0.01-5 V/meter pipe.

In an embodiment of the offshore pipe system the electrically conductive armor layer is arranged on the inside of the sealing sheath. The sealing sheath may conveniently be the innermost sealing sheath and the electrically conductive layer will then constitute the carcass of the unbonded flexible pipe, and the carcass is normally in direct contact with the fluid to be heated. However, in some embodiments the carcass may be covered with a permeable liner, e.g. to reduce the risk of vortex formation in the fluid passing through the bore of the unbonded flexible pipe. Vortex formation may cause undesired vibrations in the flexible pipe.

In an alternative embodiment of the offshore pipe system the electrically conductive armor layer is arranged on the outside of the sealing sheath. This embodiment may be suitable if it is not desirable that the temperature affecting the fluid transported in the pipe is changed to fast, i.e. the sealing sheath may also form a thermal barrier which will serve to reduce rapid changes in temperature.

In the offshore pipe system according to invention the electrically conductive armor layer of the first unbonded flexible pipe may be grounded. Alternatively, the electrically conductive armor layer of the second unbonded flexible pipe may be connected with ground, or both armor layers may simultaneously be connected to ground.

For a structure operating in sea water, zero potential or ground (or “earth”) is generally equal to the potential of the sea water and is herein defined as the potential of the sea water.

When a voltage is impressed over the electrically conductive layers using the power supply, at least one of the electrically conductive layers will usually have a relatively high electric potential or a relative low electric potential relative to zero.

For example the power supply can be connected to provide the electrically conductive layer of the first flexible pipe with a relatively high or relatively low potential and the electrically conductive armor layer of the second flexible pipe can be connected to zero.

In an embodiment the first electrically conductive layer is impressed by a master potential and the second electrically conductive layer is impressed by a slave potential, adjusted such that the summarized current though the two conductive layer is zero. In this situation there is no net current floating from the far connected structure and the far connected structure will rest on equilibrium potential relative to the surroundings.

For example two unbonded flexible pipes with exact the same resistance are coupled according to the invention. The electrically conductive armor layer of the first flexible pipe is impressed by 100 V and the electrically conductive armor layer of the second flexible pipe is impressed with −100 V using the sea water potential as zero. Thereby a voltage drop of 200 V can be provided at the second ends, preferably at the second end-fitting the voltage is relatively low. This is an advantage since no or only little protection at the second end against galvanic corrosion will be desired or required.

The embodiment described above can easily be realized by coupling the two ends of the system to an electrically floating power supply. In this situation, the voltage drop over the terminals will determine the current through the conductive armor layers. Upon operation the floating terminals of the power supply will adjust themselves such that the far connecting point will adjust itself to equilibrium potential.

In an embodiment the impressed voltage by the power supply is adjusted such that the voltage drop over the electrically conductive layer of the first flexible pipe relative to the voltage drop over the electrically conductive armor layer of the second flexible pipe ensures that the potential at the second end of the unbonded flexible pipes is substantially zero.

In an embodiment the electrically conductive armor layer and/or the electrically conductive armor layer is adapted to be grounded preferably at the second end of the unbonded flexible pipes.

The power supply can be applied as a single power supply or it can be in the form of two or more electrically cooperating and/or connected sub-power supplies. In an embodiment the power supply is a dual power supply where one sub-power supply is connected over one of the electrically conductive layers and zero and it adds a high potential to the first of the electrically conductive layers and another sub-power supply is connected over the other one of the electrically conductive layers and zero and it adds a low potential to the second one of the electrically conductive layers.

In an embodiment the risk of galvanic corrosion of metal parts is at least partly alleviated by applying a support power supply in the electric circuit at a distance from the power supply. Such support power supply is advantageously applied at the second end of the unbonded flexible pipes for example in a second-end end-fitting.

The support power supply advantageously impresses an electrical potential difference between the electrically conductive layers at the second end of the unbonded flexible pipes such that the impressed electrical potential at the second end of each of the respective electrically conductive layers is negative where the electrical potential impressed by the power supply at the first end of the unbonded flexible pipes to each of said respective electrically conductive layers is positive and positive where the electrical potential impressed by the power supply at the first end of the unbonded flexible pipes to each of said respective electrically conductive layers is negative.

Preferably at least one of the electrical connections for connecting to the main power supply is arranged in the first end fitting. In an embodiment both of the electrical connections are arranged in the first and the second end fitting.

In an embodiment both of the electrical connections for connecting the power supply are arranged in the first end fitting such that a high electric potential is impressed at the first electrically conductive armor layer and a low electric potential is impressed at the electrically conductive armor layer by the power supply. Advantageously the electrically second conductive armor layer is grounded at a distance from the first end fitting, such as in or near the second end.

In order to provide a relatively long section of the unbonded flexible pipes with a heating function (i.e. with the electric circuit provided by the electrically conductive layers and one or more power supplies) it is generally desired that the first electrically conductive armor layer is electrically connected with the second electrically conductive armor layer at a distance of at least about 50 m, such as at least about 100 m, such as at least about 300 m along the length of the unbonded flexible pipes from the first and second end fitting. The distance may be up 1, 2 or even 5 km or optionally longer. However, in some situations it will be sufficient to have the heating function in only a length section of the unbonded flexible pipes, such as an uppermost length section, whereas in other situations the unbonded flexible pipes advantageously have the heating function in their entire length.

In an embodiment the unbonded flexible pipes each comprise a second-end end fitting connected to their second end. Advantageously the first electrically conductive armor layer is electrically connected with the second electrically conductive armor layer by means of their second-end end fittings optionally via a support power supply as described above. Thus, the interconnection between the first electrically conductive armor layer and the second electrically conductive armor layer may be provided by a simple conductive connection in the second-end end fittings.

In an embodiment at least the electrically conductive layers are mechanically terminated in the second-end end fittings.

In an embodiment the electrical connections arranged to apply a voltage over the electrically conductive layers are arranged to be connected to a power supply in the form of an electric heating system for impressing the voltage over the electrically conductive layers in the first and the second end fitting.

In an embodiment the electrical connections arranged to apply a voltage over the electrically conductive layers are arranged for application of an alternating voltage or current (AC).

In an embodiment the electrical connections arranged to apply a voltage over the electrically conductive layers are arranged for application of direct voltage or current (DC).

The electrically conductive armor layers are in an embodiment adapted to be grounded for example in their first end thereby reducing the electric field generated from the electrically conductive armor layers since their electric potential will be held relatively close to the electric potential of the surrounding water when the unbonded flexible pipe is in use. In an embodiment where the electrically conductive armor layers are adapted to be grounded, the grounding is applied to the first electrically conductive armor layer via the first end fitting.

In an embodiment the electrical connections are arranged to apply a voltage over the electrically conductive armor layers and comprise a single voltage conductor electrically connected to the first electrically conductive armor layer, and the second electrically conductive armor layer is grounded such that the AC or DC return current is guided through the ground and/or through the second electrically conductive armor layer.

In the offshore pipe system according to the invention the electrically conductive armor layer of the first unbonded flexible pipe may correspond to the electrically conductive armor layer of the second unbonded flexible pipe. Alternatively, the electrically conductive armor layer of the first unbonded flexible pipe is different from the electrically conductive armor layer of the second unbonded flexible pipe.

If the electrically conductive armor layer of the first unbonded flexible pipe corresponds to the electrically conductive armor layer of the second unbonded flexible pipe, substantially the same amount of heat is generated in the pipes when a voltage is applied to the system. This is due to the fact that the electrically conductive armor layers are made from the same material with substantially the same electrical resistances.

However, the two electrically conductive armor layers may also be made from different materials, such as different steel alloys with different electrical resistances. Thus, different amounts of heat may be generated in the two flexible pipes. Moreover, the two unbonded flexible pipes may have different lengths, which may also have an impact on the amount of heat generated in the electrically conductive armor layers.

In an embodiment of the offshore pipe system according to the invention, the system comprises at least a third unbonded flexible pipe, which unbonded flexible pipe has a length along a longitudinal center axis, and a first and a second end, and comprises a sealing sheath and an electrically conductive armor layer. Moreover, the system may further comprise at least a third end fitting connected to the first end of the at least third unbonded pipe.

The third unbonded pipe may be electrically connected with the first and the second unbonded pipe, optionally via the end fittings and the second ends. The pipes may be connected in the following manner. The first unbonded flexible pipe is connected with a power supply which sends a current through the electrical conductive armor of the first pipe, which current then is returned via the electrical conductive armors of the second and the third pipe. This embodiment may e.g. be advantageous in situations where it is desirable to send a relative high current through the electrical conductive armor of the first flexible pipe and a lower current through the electrical conductive armors of the second and third pipe. Such a situation may e.g. appear when the material of the first electrical conductive armor is different from the material of the second and third electrical conductive armors and the armors have different electrical properties. It may easily be realized that the offshore pipe system may also comprise four or more unbonded flexible pipes.

The offshore pipe system according to the invention also comprises an embodiment in which the offshore pipe system comprises at least one sacrificial anode.

When a voltage is applied over the electrically conductive layers, they will—as mentioned—usually have a relatively high electric potential or a relative low electric potential relative to metal parts of the end fitting and/or metal parts of the production site structure. Such electric potential difference may without an electric power blocking likely result in damaging of metal parts of the end fittings and/or the production site to which the unbonded flexible pipes are connected due to galvanic corrosion. By providing an electric power blocking which reduces galvanic reaction between the electrical conductive armor layers and the metal parts of the production site structure, such damage can be reduced or even avoided. Whereas the electrical insulation of an annular wall surface defining the bore of the first end fitting results in a reduced risk of galvanic corrosion, the electric power blocking provides an additional corrosion protection of the whole system including the production site structure to which the unbonded flexible pipe is to be connected.

The electric power blocking can be any kind of physical and/or chemical blocking that blocks field lines from the electrical conductive armors and with vector direction to the flange of the rear part and/or to the production site structure when mounted thereto.

In an embodiment the electric power blocking is a valve, such as a ball valve or a gate valve, preferably the valve is of nonconductive material or is coated with a nonconductive material.

In an embodiment the electric power blocking is provided by a bend e.g. a fluid trap provided by a J-bend, a U-bend or an S-bend.

However, in an embodiment the electric power blocking is a sacrificial anode comprising a metal or a metal alloy which is less noble than the annular wall surface of the end fittings, such as an anode comprising magnesium, brass, aluminum, zinc or titanium.

The sacrificial anode can be any kind of sacrificial anode for the material it is supposed to protect.

In an embodiment the sacrificial anode is applied in an annular pattern in an annular wall section at the rear end of the end fittings. It may for example be applied in the form of a ring partly embedded in the annular wall section.

Sacrificial anodes and offshore sacrificial anodes are well known in the art for use in cathodic protection. In the present situation the sacrificial anode has the function of blocking electric power transmission to the annular wall surface of the end fittings and/or to any metal that the end fittings may be connected to, thereby avoiding undesired electrolytic reactions between the electrical conductive armors layers and any metal that the end fittings may be connected to.

The metal anodes are usually made of a metallic element or alloy which corrodes more easily than the metal it protects. The electrons that are removed from the sacrificial anode are conducted to the protected metal, which then becomes the cathode. This cathode is protected from oxidation because reduction (rather than corrosion) occurs on the protected metals.

In some cases, the negative potential of magnesium can be a disadvantage: If the potential of the protected metal becomes too negative, hydrogen ions may be evolved on the electrical conductive armors surfaces leading to hydrogen embrittlement which may damage the electrical conductive armors.

Zinc is normally a reliable material, but where the temperature is too high the zinc tends to become less negative; if this happens, current may cease to flow and the anode stops working.

In an embodiment the sacrificial anode is a plating/electro plating anode. Typically, plating anodes and anodes are made of brass, bronze, cadmium, copper, lead, nickel, tin, or zinc. Alloys for these metal anodes include cadmium-tin, copper-tin, copper-zinc, tin-lead, tin-zinc, zinc-aluminum, zinc-magnesium, and zinc-nickel.

In an embodiment the sacrificial anode is a mixed metal oxide (MMO) anode. An MMO anode comprises an oxide coating over an inert metal or carbon core. The oxides consist of precious metal (Ru, Ir, Pt) oxides for catalyzing an electrolysis reaction.

Titanium oxides are used for inertness, electrode corrosion protection, and lower cost. The core metals are typically titanium (most common), zirconium, niobium, or tantalum.

Moreover, to avoid any undesired current in the offshore pipe system, the sealing sheath is electrically insulating. Each pipe in the system may comprise more layers and the electrical conductive armor layer in each pipe should be insulated from the other layers in the pipe, e.g. by means of the electrically insulating sealing sheath.

The invention also comprises a method for heating pipes in an offshore pipe system comprising at least a first unbonded flexible pipe and a second unbonded flexible pipe for transportation of fluids, where each of the unbonded flexible pipes has a length along a longitudinal center axis, and a first and a second end. Furthermore each of the unbonded flexible pipes comprises a sealing sheath and an electrically conductive armor layer, and the method comprises the steps of:
establishing an electrical connection between the electrically conductive armor layer of the first unbonded flexible pipe and the electrically conductive armor layer of the second unbonded flexible pipe to form an electrical circuit; and
connecting the electrical circuit with a power supply capable of sending an electric current through the electrical circuit to heat the electrically conductive armor layers.

Thus, the method provides a simple manner of heating at least a first and second pipe in an offshore pipe system by passing an electrical current through an electrical conductive armor layer in each pipe. The electrical conductive armor layers are most likely made from a metallic material which is electrically conductive, but also having an electrical resistance which will cause the material to get warm when a current passes through.

By use of the method a number of externally mounted wiring and conductors may be avoided, which makes the method highly cost-effective.

For the purpose of obtaining a sufficient heating the electrical current through the electrical conductive armor layers should preferably be in the range of 10 to 15000 A, suitable in the range 50 to 5000 A.

Although electrical connections may be established in principle anywhere between the first and the second unbonded flexible pipe, it has, however, been found convenient that a first electrical connection is established between the first end fitting connected to the first end of the first unbonded flexible pipe and the second end fitting connected to the first end of the second unbonded flexible pipe. Moreover, a second electrical connection may be established between the second end of the first unbonded flexible pipe and the second end of the second unbonded flexible pipe. In this manner the whole length of the unbonded flexible pipes may be subjected to heating.

All features of the invention including ranges and preferred ranges can be combined in various ways within the scope of the invention, unless there are specific reasons not to combine such features.

### DESCRIPTION OF DRAWINGS

The invention will be explained more fully below in connection with a preferred embodiment and with reference to the drawings in which:

FIG. 1 shows an embodiment of a pipe system according to the invention;

FIG. 2 shows a schematically depiction of the electric circuit;

FIG. 3 shows an embodiment of a flexible pipe;

FIG. 4 shows an end fitting according to the invention;

FIG. 5 shows an alternative embodiment of the pipe system

The drawings are only schematically and only intended for showing the principles of the present invention and some details which do not form part of the invention have been omitted. The same reference numbers may be used for the same parts in the drawings.

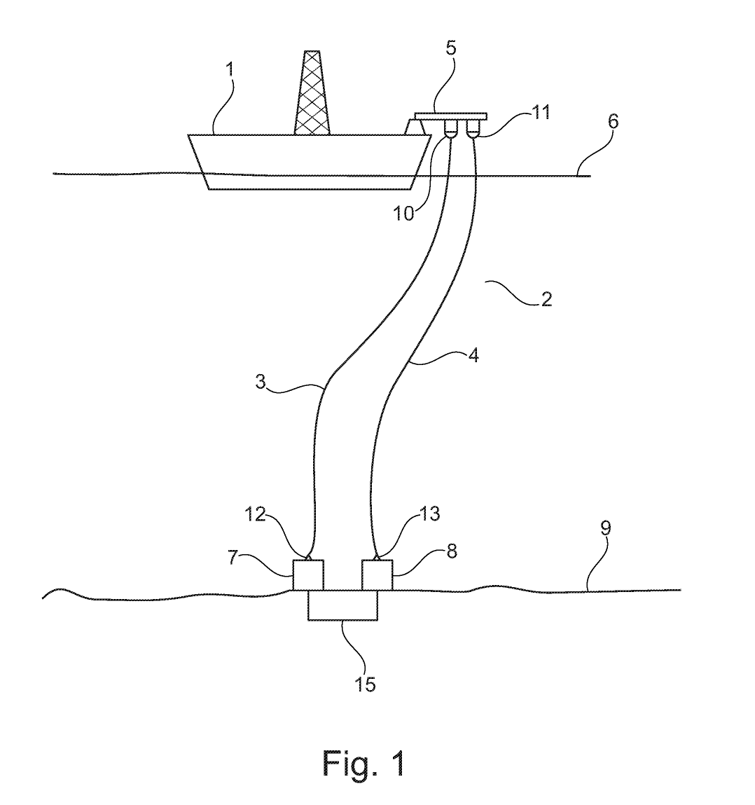

FIG. 1 shows a floating production unit 1 which comprises an offshore pipe system 2 according to the invention. The floating production unit 1 is connected with a first unbonded flexible pipe 3 and a second unbonded flexible pipe 4. The pipes 3 and 4 are connected with the floating production unit 1 via a bearing structure 5 above the sea line 6.

At their second ends the pipes 3 and 4 are connected to subsea facilities 7 and 8 located at the seabed 9.

The unbonded flexible pipes 3 and 4 each comprise a layer which is electrically conductive. In this particular embodiment the electrically conductive layer is the inner armor layer, i.e. the carcass which is made from an electrically conductive stainless steel.

The pipes 3 and 4 are at their first ends connected to the bearing structure 5 via a first end fitting 10 and a second end fitting 11. At their second ends the unbonded flexible pipes 3 and 4 are connected with the subsea facilities 7 and 8 via second-end end fittings 12 and 13.

All the end fittings in the offshore pipe system 2 is equipped with electrical wiring and connection which allow the end fittings to transfer an electric current from a power supply to the carcasses of the pipes 3 and 4 and electrical connections between the carcasses. In FIG. 1 the power supply is not shown, however, the power supply is placed on the floating production unit 1 and the electric power is generated by an engine on the floating production unit.

Thus, the electrical current from the power supply is sent via the first end fitting 10 through the carcass of the first pipe 3 to the end fitting 12. The end fitting 12 is connected with the subsea facility 7, which is electrically connected with the subsea facility 8 via the connection line 15. From the subsea facility the electrical current passes through the end fitting 12 and into the carcass of the second pipe 4, and to the second end fitting 11 from which it is returned to the power supply.

The above description basically describes how the system works with direct current. In case of alternating current the direction of the current will change in response to the frequency of the impressed voltage. However, sending a current through an electrically conductive layer in a flexible pipe is already known and a skilled person will be able to adapt the present invention to be operated with direct current (DC) or alternating current (AC) respectively.

Although the connection line 15 between the subsea facilities is shown as being below the seabed 9, the connection line 15 may also be placed directly on the seabed 9 or above the seabed if desired.

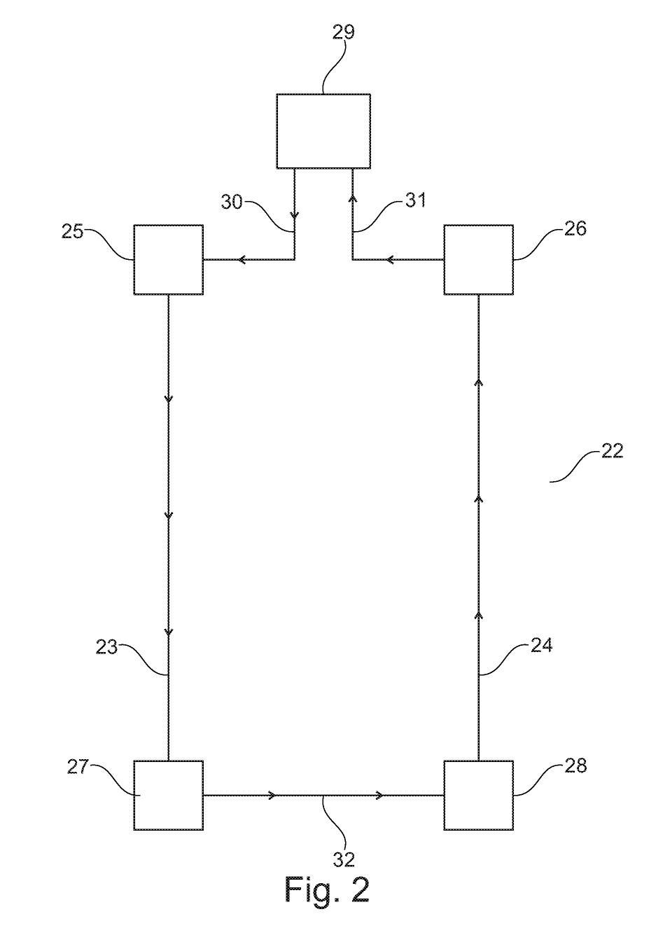

FIG. 2 is a schematically depiction of the electric circuit in the offshore pipe system shown in FIG. 1.

The electrical circuit 22 comprises a first electrical conduit 23 and a second electrical conduit 24. The first electrical conduit 23 extends between the connection points 25 and 27. In a similar manner the second electrical conduit 24 extends between the connection points 23 and 27. In this respect, the electrical conduits 23 and 24 illustrate the electrically conductive layers of the unbonded flexible pipes and the electrical connections points 25, 26, 27 and 28 correspond to end fittings in the offshore pipe system in FIG. 1.

The electrical circuit 22 also comprises a power source 29, which sends electric power through the electric conduits 23 and 24 via wires 30 and 31 and connection line 32. In FIG. 2 the electric power travels in the circuit 22 in one direction which is the case when direct current is applied. Due to the electrical resistance in the electrical conduits 23 and 24, the electric current passing though the conduits will cause the temperature to increase in the conduits and thus provide a heating effect.

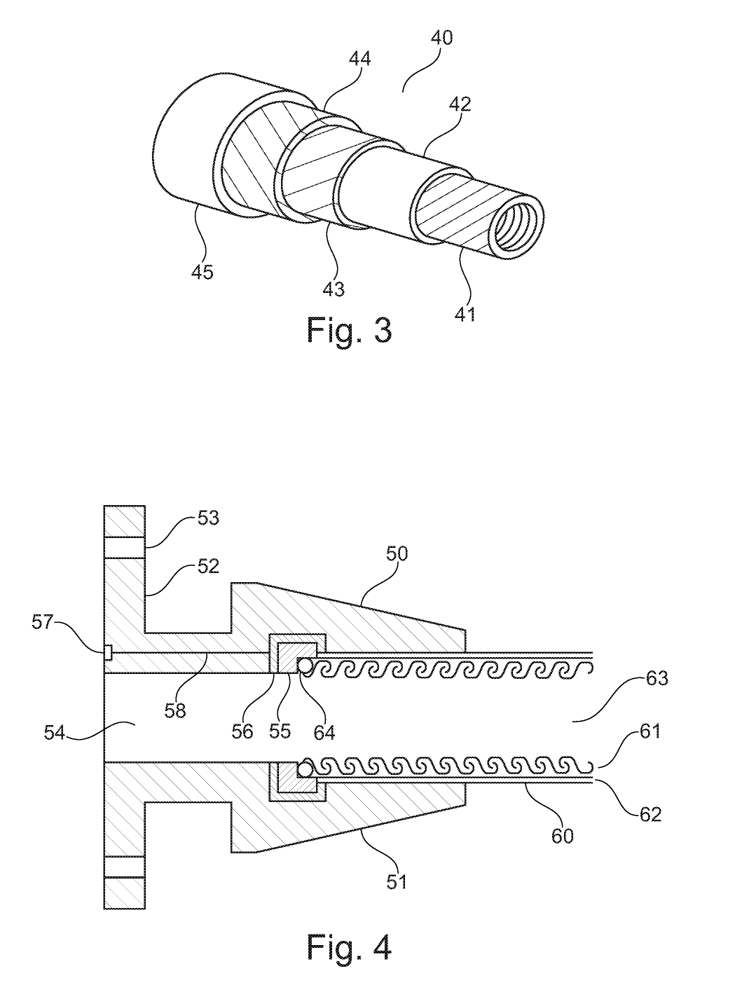

FIG. 3 shows section of an unbonded flexible pipe 40 suitable for use in the offshore pipe system according to the invention. From the inside an out the pipe comprises an armor layer 41, a sealing sheath 42, a second armor layer 43 and a third armor layer 44, and finally a sealing sheath 45.

The inner armor layer 41 is normally known as the carcass and comprises an elongate strip wound to form a tube. The elongate strip is in most cases made from steel, in particular stainless steel. However, for some purposes the carcass may be made from other materials, such as polymer material or composite materials.

The sealing sheath 42 is referred to as the innermost sealing sheath and is covering the carcass or inner armor layer 41. The innermost sealing sheath is constituted by an extruded layer of polymer material, such as poly ethylene. Normally the sealing sheath 42 is substantially impermeable to liquid and also electrically insulating.

The armor layers 43 and 44 are normally known as tensile armors. The layers 43 and 44 may be made from metal wires or wires of polymer or composite material.

The sealing sheath 45 is normally referred to as the outer sealing sheath. The outer sealing sheath 45 is conveniently an extruded layer of polymer material, e.g. polyethylene.

When the unbonded flexible pipe 40 is used in the offshore pipe system according to the invention, the electrically conductive layer will usually be the inner armor layer 41. As mentioned the carcass or inner armor layer is in most cases made from metal, such as stainless steel which is electrically conductive and has a suitable electrical resistivity around 10⁻⁸ ρ (Ωm).

Alternatively one of the layers 43 or 44 may be used as electrically conductive layer. These layers are often made from metal, e.g. from stainless steel.

FIG. 4 shows a schematical section of an end fitting 50 comprising electric wiring for connecting an electrical conductive layer in a flexible pipe with a power supply.

The unbonded flexible pipe 60 which is terminated in the end fitting 50 is only shown with the carcass 61 and the sealing sheath 62. In this embodiment the carcass 61 is the electrically conductive layer. In practice the unbonded flexible pipe may comprise more layers as shown in FIG. 3 and these layers may be terminated in the end fitting in a conventional manner.

Consequently, the end fitting 50 is shown in a simplified embodiment showing the housing 51 and mounting flange 52 with holes 53 for bolt.

The pipe 60 has a bore 63 defined by the carcass 61 for transporting fluids. The bore 63 corresponds with a bore 54 in the end fitting 50. The carcass 61 is terminated with a carcass end ring 64 which is in electric contact with an electrically conducting ring shaped member 55 mounted in the end fitting 50. The electrically conducting ring shaped member 55 is insulated from the end fitting 50 by the insulator 56.

The electrically conducting ring shaped member 55 is connected with a connection point or contact 57 in the mounting flange 52 via the electric wire 58. The bore 54 of the end fitting may be coated with an insulating material to reduce the risk of galvanic corrosion in the end fitting when an electric current is send through the carcass 61.

In the embodiment shown in FIG. 4, the electric contact 57 is mounted in the flange 52. However, it is also possible to place the contact 57 differently, e.g. in a side surface of the end fitting.

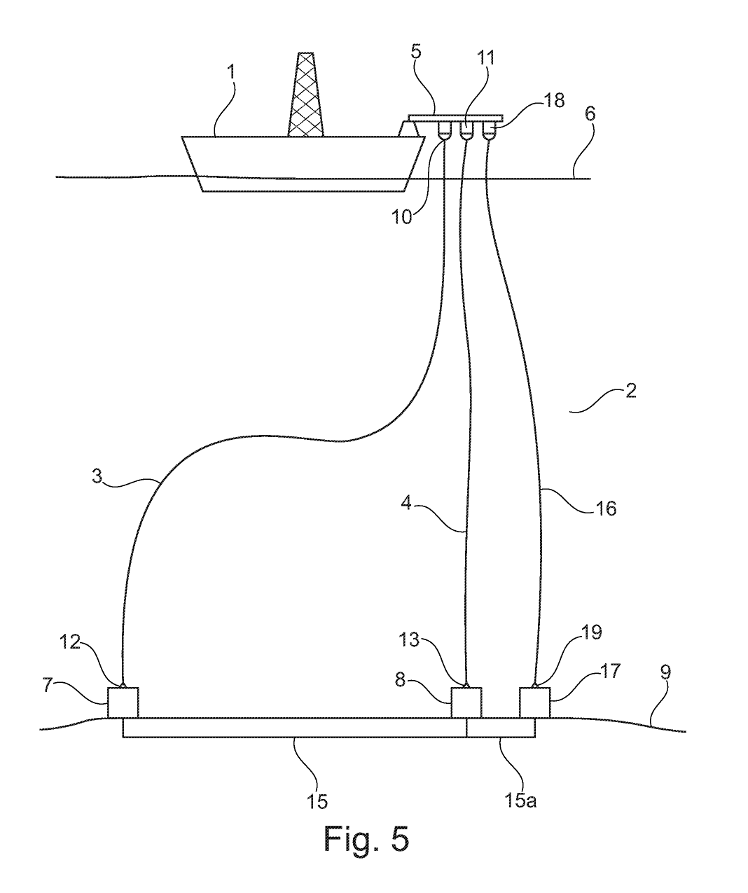

FIG. 5 shows an embodiment of the offshore pipe system comprising three pipes.

Basically the offshore pipe system 2 shown in FIG. 5 corresponds to the system shown in FIG. 1, in which a floating production unit 1 comprises an offshore pipe system 2 according to the invention. The floating production unit 1 is connected with a first unbonded flexible pipe 3, a second unbonded flexible pipe 4, and a third unbonded flexible pipe 16. The pipes 3, 4 and 16 are connected with the floating production unit 1 via a bearing structure 5 above the sea line 6.

At their second ends the pipes 3, 4 and 16 are connected to the subsea facilities 7, 8 and 17 located at the seabed 9.

The unbonded flexible pipes 3, 4 and 16 each comprise a layer which is electrically conductive.

The pipes 3, 4 and 16 are at their first ends connected to the bearing structure 5 via a first end fitting 10, a second end fitting 11, and a third end fitting 18. At their second ends the unbonded flexible pipes 3, 4 and 16 are connected with the subsea facilities 7, 8 and 17 via second-end end fittings 12, 13 and 19.

All the end fittings in the offshore pipe system 2 is equipped with electrical wiring and connection which allow the end fittings to transfer an electric current from a power supply to the electrically conductive layers of the pipes 3, 4, 16 via electrical connections between the electrical conductive layers. In FIG. 5 the power supply is not shown, however, the power supply is placed on the floating production unit 1 and the electric power is delivered from a generator on the floating production unit.

The electrical current from the power supply is sent via the first end fitting 10 through the carcass of the first pipe 3 to end fitting 12. The end fitting 12 is connected with the subsea facility 7, which is electrically connected with the subsea facility 8 via the connection line 15, which via connection line 15a is further connected with the subsea facility 17. From the subsea facilities the electrical current passes through the end fittings 13 and 19 into the electrically conductive layers of the second pipe 4 and the third pipe 16, and to the second end fitting 11 and the third end fitting 18 from which it is returned to the power supply to close the electrical circuit.

Thus, the electric current is sent to the seabed 9 via the pipe 3 and returned to the sea line 6 via the pipes 4 and 16. As it may be seen in FIG. 5 the unbonded flexible pipe 3 is significantly longer than the unbonded flexible pipes 4 and 16, and although the returning current is divided to run in two electrically conductive layers, the current will still be able to provide a heating effect in the two electrically conductive layers. Each of the electrically conductive layers of the pipes 4 and 16 will have a shorter length than the length of the electrically conductive layer in the pipe 3,

In respect of the direction of the current, this will only be true when applying direct current to the offshore pipe system. However, a skilled person will also know how to apply alternating current to the offshore pipe system.

A skilled person will also be able to adapt the offshore pipe system to other combinations of three or more pipes. Moreover, a skilled person will be able to select suitable electrically conductive material for the electrically conductive armor layer, e.g. among electrically conductive steel alloys.

1. An offshore pipe system comprising a first unbonded flexible pipe and a second unbonded flexible pipe for transportation of fluids, each of said unbonded flexible pipes has a length along a longitudinal center axis, and a first and a second end, each of said unbonded flexible pipes comprises a sealing sheath and an electrically conductive armor layer, the system further comprises a first end fitting connected to the first end of the first unbonded flexible pipe and a second end fitting connected to the first end of the second unbonded flexible pipe wherein the electrically conductive armor layer of the first unbonded flexible pipe is electrically connected with the electrically conductive armor layer of the second unbonded flexible pipe via a first electrical connection and a second electrical connection, the first and second electrical connections are applied with a distance along the length of the first unbonded flexible pipe and the second unbonded flexible pipe, respectively.

2. The offshore pipe system according to claim 1, wherein the electrically conductive layer of the first unbonded flexible pipe is impressed with an electrical potential via its first electrical connection and the electrically conductive layer of the second unbonded flexible pipe is impressed with an electrical potential via its second electrical connection such that the summarized charge flowing through the first and the second unbonded flexible pipe is substantially zero (zero net charge).

3. The offshore pipe system according to claim 1, wherein the first end of the first unbonded flexible pipe is connected to a master potential and the potential of the second end of the second unbonded flexible pipe is actively adjusted to provide substantially zero net flow of current through the system.

4. The offshore pipe system according to claim 1, wherein the first end of the first unbonded flexible pipe and the second end of the second unbonded flexible pipe are connected to the two terminals of a power supply which is electrically floating.

5. (canceled)

6. (canceled)

7. The offshore pipe system according to claim 1, wherein the electrically conductive armor layer is arranged on the inside of the sealing sheath.

8. (canceled)

9. The offshore pipe system according to claim 1, wherein the electrically conductive armor layer is arranged on the outside of the sealing sheath.

10. (canceled)

11. (canceled)

12. The offshore pipe system according to claim 1, wherein the first electrical connection is applied between the first and the second end fitting.

13. The offshore pipe system according to claim 1, wherein the second electrical connection is applied between the second end of the first unbonded flexible pipe and the second end of the second unbonded flexible pipe.

14. The offshore pipe system according to claim 1, wherein the electrically conductive armor layer of the first unbonded flexible pipe is connected with ground.

15. The offshore pipe system according to claim 1, wherein the electrically conductive armor layer of the second unbonded flexible pipe is connected with ground.

16. (canceled)

17. (canceled)

18. The offshore pipe system according to claim 1, wherein the system comprises at least a third unbonded flexible pipe, said unbonded flexible pipe has a length along a longitudinal center axis, and a first and a second end, said unbonded flexible pipe comprises a sealing sheath and an electrically conductive armor layer.

19. The offshore pipe system according to claim 1, wherein, the system further comprises at least a third end fitting connected to the first end of the at least third unbonded pipe.

20. The offshore pipe system according to claim 1, wherein the third unbonded pipe is electrically connected with the first and the second unbonded pipe.

21. An offshore pipe system according to claim 1, wherein the offshore pipe system comprises at least one sacrificial anode.

22. (canceled)

23. A method for heating pipes in an offshore pipe system comprising at least a first unbonded flexible pipe and a second unbonded flexible pipe for transportation of fluids, each of said unbonded flexible pipes has a length along a longitudinal center axis, and a first and a second end, each of said unbonded flexible pipes comprises a sealing sheath and an electrically conductive armor layer, said method comprises the steps of:
establishing an electrical connection between the electrically conductive armor layer of the first unbonded flexible pipe and the electrically conductive armor layer of the second unbonded flexible pipe to form an electrical circuit; and
connecting the electrical circuit with a power supply capable of sending an electric current through the electrical circuit to heat the electrically conductive armor layers.

24. (canceled)

25. The method according to claim 23, wherein a first electrical connection is established between a first end fitting connected to the first end of the first unbonded flexible pipe and a second end fitting connected to the first end of the second unbonded flexible pipe.

26. The method according to claim 23, wherein a second electrical connection is established between the second end of the first unbonded flexible pipe and the second end of the second unbonded flexible pipe.

27. The method according to 23, wherein the first end of the electrically conductive layer of the first unbonded flexible pipe is impressed with a master potential and the second end of the electrically conductive layer of the second unbonded flexible pipe is impressed with a slave potential.

28. The method according to claim 23, wherein the master potential and the slave potential are adjusted such that the summarized current though the electrically conductive layer of the first unbonded flexible pipe and the electrically conductive layer of the second unbonded flexible pipe is substantially zero.

29. The method according to claim 23, wherein the offshore system comprises:
a first end fitting connected to the first end of the first unbonded flexible pipe and a second end fitting connected to the first end of the second unbonded flexible pipe, and
wherein the step of establishing an electrical connection is performed via a first electrical connection and a second electrical connection, the first and second electrical connections are applied with a distance along the length of the first unbonded flexible pipe and the second unbonded flexible pipe, respectively.
